(19) United States
(12) Patent Application Publication
(10) Pub. No.: US 2008/0150869 A1
(43) Pub. Date: Jun. 26, 2008

(54) DISPLAY PANEL AND PLANE DISPLAY DEVICE USING THE SAME

(75) Inventor: Chin-Hung Hsu, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: NOVATEK MICROELECTRONICS CORP., Hsinchu (TW)

(21) Appl. No.: 11/674,672

(22) Filed: Feb. 14, 2007

(30) Foreign Application Priority Data
Dec. 26, 2006 (TW) 95148914

(51) Int. Cl. G09G 3/36; G09G 3/20

(52) U.S. Cl. 345/96; 345/55; 345/88

(57) ABSTRACT

A display panel and a plane display device applying the same are provided in the invention. Inside the display panel, the route of one data line changes from one column to another so as to connect with pixels in different columns. The data line also transmits data of pixels in different columns accordingly. Thus, when different rows of scan lines operate in the same frame, the driving polarity of the data line does not have to invert. Another display panel is further provided, including two common electrode layers connected to different voltages. Pixels at different positions may be perpendicularly arranged to correspond to different common electrode layers. Therefore, the driving polarities of pixels are inverted. Both display panels can achieve the display effect of the dot inversion, reduce the shifting back and forth between the positive and negative polarities and lower the power consumption.

### CROSS-REFERENCE TO RELATED APPLICATION

This application claims the priority benefit of Taiwan application serial no. 95148914, filed on Dec. 26, 2006. All disclosure of the Taiwan application is incorporated herein by reference.

### BACKGROUND OF THE INVENTION

1. Field of the Invention

The present invention relates to a display device, especially to a display panel with low power consumption and high display quality and a plane display device using the same.

2. Description of Related Art

The thin film transistor liquid crystal display (TFT LCD) utilizes the liquid crystal as the material for controlling the displaying. As shown in FIG. 1, it illustrates a structure diagram of a conventional display panel. A display panel 100 includes a thin film transistor array substrate 103, a color filter substrate 104 and a liquid crystal layer 102. The thin film transistor array substrate 103 includes a thin film transistor 107 and a pixel electrode 105. The color filter substrate 104 includes a common electrode layer 101 and a black opaque layer 106. In order to prevent the liquid crystal molecules in the liquid crystal layer 102 from being polarized by the electrical field, positive or negative polarity inversion driving methods are required, such as frame inversion, column inversion and dot inversion.

The frame inversion driving method is shown in FIG. 2. FIG. 2 illustrates the driving polarities of the pixels of a TFT LCD in the frame T and the next frame T+1. + indicates a positive polarity driven mode, and − represents a negative polarity driven mode. It can be seen from FIG. 2 that the so-called frame inversion means all the pixels in one frame have the same driving polarity either in the horizontal or the vertical direction. The driving polarity of the same pixel is inverted when entering the next frame and all the pixels have the same driving polarities. Although the frame inversion driving method has the advantage of less power consumption, it has disadvantages such as all pixels of the same frame having the same polarity, more obvious flickering in the frame, serious crosstalk caused by the interference of coupling and inferior display quality.

FIG. 3(a) illustrates the column inversion driving method. Referring to FIG. 3(a), it illustrates the driving polarities of the pixels of a TFT LCD in the frame T and the next frame T+1. + indicates a positive polarity driven mode, and − represents a negative polarity driven mode. It can be seen from FIG. 3(a) that in the same frame, adjacent pixels in the vertical direction have opposite driving polarities. The driving polarity of each pixel is inverted when entering the next frame. The disadvantages of the line inversion driving method are that the frame still has slight flickering and crosstalk.

In addition, the dot inversion driving method is shown as in FIG. 3(b). FIG. 3(b) illustrates the driving polarities of the pixels of a TFT LCD in the frame T and the next frame T+1. + indicates a positive polarity driven mode, and − represents a negative polarity driven mode. It can be seen from FIG. 3(b) that in the same frame, adjacent pixels either in the horizontal or vertical direction have opposite driving polarities. The driving polarity of one pixel is inverted when entering the next frame. Although the dot inversion driving method has the best display quality, it has a disadvantage of consuming more power.

Referring to FIG. 4, a source driver 401 in FIG. 4 outputs signals through data lines on the vertical axis DL1-DL3 to pixels in the same horizontal scan line (SL), PA, PB and PC, in a pixel matrix 402. Nowadays most large-screen TFT LCD panels are designed to use a direct current common voltage Vcom. Thus, there are a positive polarity voltage higher than the common voltage Vcom and a negative polarity voltage lower than the common voltage Vcom. For example, the voltage polarities outputted from the data lines DL1 and DL3 are, in sequence, positive, negative and positive, and the voltage polarities outputted from the data line DL2 are, in sequence, negative, positive and negative. Every time when entering the next scan line or the next frame, the voltage polarities of the data lines DL1-DL3 must be inverted. Therefore, a source driver 401 has to provide a cross voltage Vswing two times of the common voltage Vcom. The larger the cross voltage Vswing gets, the more power is consumed. As the display panel gets bigger, the resolution increases and the wide view angle technology needs higher voltages for driving, the problem becomes more visible.

### SUMMARY OF THE INVENTION

The present invention provides a display panel. Each of the data lines thereof is coupled to pixels of different columns. When scan lines of different rows are operating in the same frame, data are transmitted at the same time without changing the driving polarities of the data lines, and thus the display effect of the dot inversion is achieved.

The invention further provides a plane display device. The display panel thereof has the display quality and effect of the dot inversion. When scan lines of different rows are operating in the same frame, the driving polarities of the data lines need not be changed. The driving polarities of the data lines are changed only when the frame changes. Hence, the number of times of changing the capacitor-crossing voltage is reduced so as to lower power consumption.

The invention further provides a display panel with two common electrode layers coupled to different voltages. Pixels at different positions may be vertically arranged to correspond to different common electrode layers. As a result, the display quality and effect of the dot inversion driving method are achieved and the driving method lowers power consumption.

As mentioned and broadly described herein, the invention provides a display panel including M rows of scan lines, N columns of data lines and M×N pixels. M and N are positive integers, and M×N pixels are arranged into a matrix. i, j, p and q are designated as integers, 1≦i≦M, 1≦j≦N, 1≦p<M and 1≦|q|<N. The pixel on the i^{th} row and in the j^{th} column is indicated as P(i, j). The j^{th} column data line is coupled to the pixel P(i,j) and extends from between the pixel P(i+p−1,j) and the pixel (i+p,j) toward the direction between the pixel P(i+p−1,j+q) and the pixel P(i+p,j+q). The j^{th} column data line is also coupled to the pixel P(i+p, j+q) and extends between the pixel P(i+2p−1, j+q) and the pixel P(i+2p, j+q) toward the direction between the pixel P(i+2p−1,j) and the pixel P(i+2p,j).

From another aspect, the invention provides another plane display device including a timing controller, a source driver, a gate driver and a display panel. The timing controller outputs data in the order of timing. The source driver is coupled to the timing controller. The gate driver is also coupled to the timing controller. The display panel is coupled between the source driver and the gate driver. The display panel includes M rows of scan lines, N columns of data lines and M×N pixels. M and N are positive integers and M×N pixels are arranged into a matrix. i, j, p and q are designated as integers, 1≦i≦M, 1≦j≦N, 1≦p<M and 1≦|q|<N. The pixel on the i^{th} row and in the j^{th} column is indicated as P(i,j). The j^{th} column data line is coupled to the pixel P(i,j) and extends from between the pixel P(i+p−1,j) and the pixel (i+p,j) toward the direction between the pixel P(i+p−1,j+q) and the pixel P(i+p, j+q). The j^{th} column data line is also coupled to the pixel P(i+p, j+q) and extends from between P(i+2p−1,j+q) and the pixel P(i+2p, j+q) toward the direction between the pixel P(i+2p−1,j) and the pixel P(i+2p,j).

The present invention further provides a display panel suitable for use in a plane display device. The display panel includes a thin film transistor array substrate, a color filter substrate and a liquid crystal layer. The thin film transistor array substrate includes M×N pixels arranged as a matrix. M and N are positive integers. The color filter substrate includes a first common electrode layer and a second common electrode layer. A first voltage is applied to the first common electrode layer and a second voltage is applied to the second common electrode layer. The liquid crystal layer is disposed between the thin film transistor array substrate and the color filter substrate. i, j, p and q are designated as integers, and 1≦i≦M, 1≦j≦N, 1≦p<M and 1≦q<N. The pixel on the i^{th} row and in the j^{th} column is indicated as P(i,j). The pixel electrodes of the pixels P(i,j) and P(i+p,j+q) are arranged as perpendicular to the first common electrode layer. The pixel electrode of the pixel P(i+p,j) is arranged as perpendicular to the second common electrode layer.

One of the display panels of the invention has a structure wherein the route of the data line thereof changes from one column to another. Another display panel has a structure wherein pixels at different positions are perpendicularly arranged to correspond to different common electrode layers. As a result, the display quality and effect of the dot inversion quality are achieved and the power consumption is lowered.

In order to make the aforementioned and other objects, features and advantages of the present invention more comprehensible, preferred embodiments accompanied with figures are described in detail below.

### BRIEF DESCRIPTION OF THE DRAWINGS

FIG. 1 illustrates a structure diagram of a conventional display panel.

FIG. 2 is a schematic diagram of the frame inversion driving method.

FIG. 3(a) is a schematic diagram of the column inversion driving method.

FIG. 3(b) is a schematic diagram of the dot inversion driving method.

FIG. 4 is a schematic diagram of the signal wave pattern in the conventional dot inversion driving method.

FIG. 5(a) illustrates a plane display device and a data line route structure diagram of a display panel according to one embodiment of the invention.

FIG. 5(b) is a data line route structure diagram of a display panel according to another embodiment of the invention.

FIG. 6 is a data line route structure diagram of a display panel according to another embodiment of the invention.

FIG. 7(a) is a data line route structure diagram of a display panel according to another embodiment of the invention.

FIG. 7(b) is a data line route structure diagram of a display panel according to another embodiment of the invention.

FIG. 8 is a data line route structure diagram of a display panel according to another embodiment of the invention.

FIG. 9 illustrates the internal data line routes of the data line register of FIG. 8.

FIG. 10 illustrates the driving method of the embodiment of FIG. 8.

FIG. 11 is a structure diagram of a display panel according to another embodiment of the invention.

FIG. 12 is a top view of the display panel of FIG. 11.

FIG. 13 illustrates a top view of a display panel and a schematic diagram of a driving method according to another embodiment of the invention.

FIG. 14 illustrates a schematic diagram of a top view of a display panel according to another embodiment of the invention.

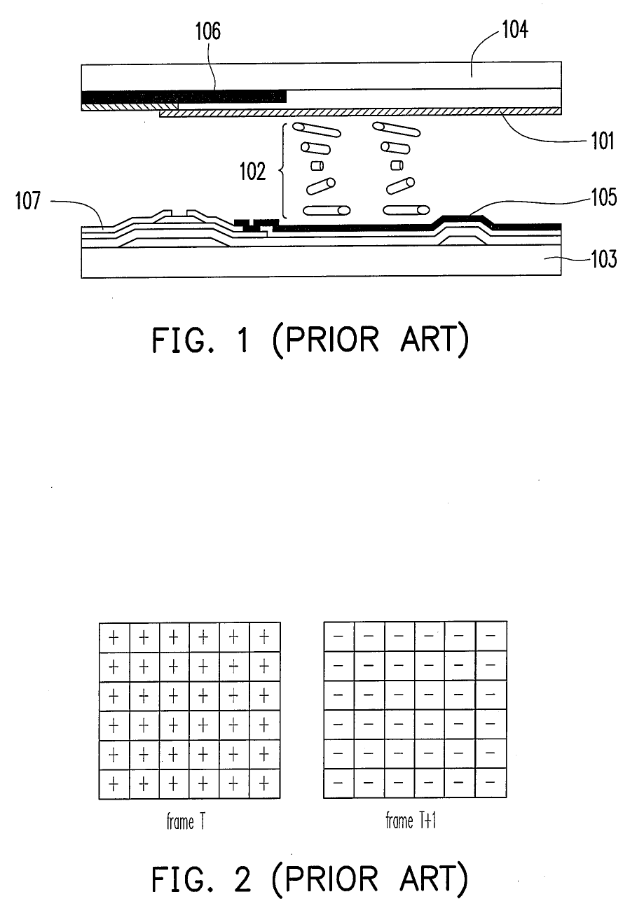

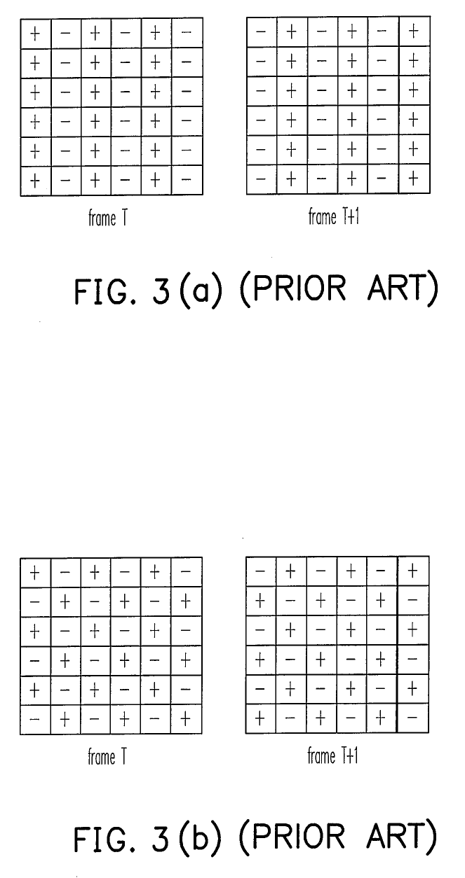

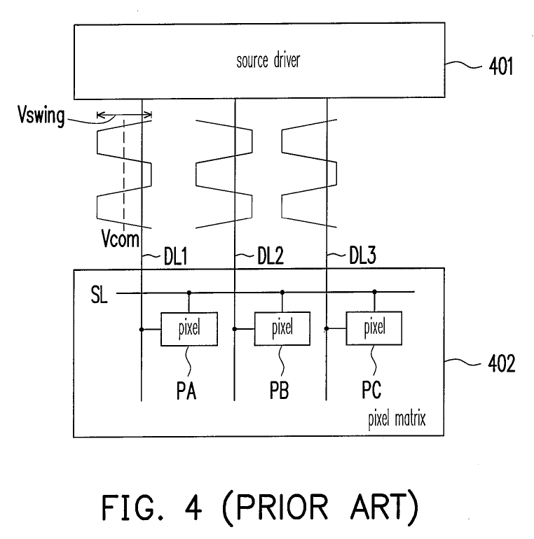

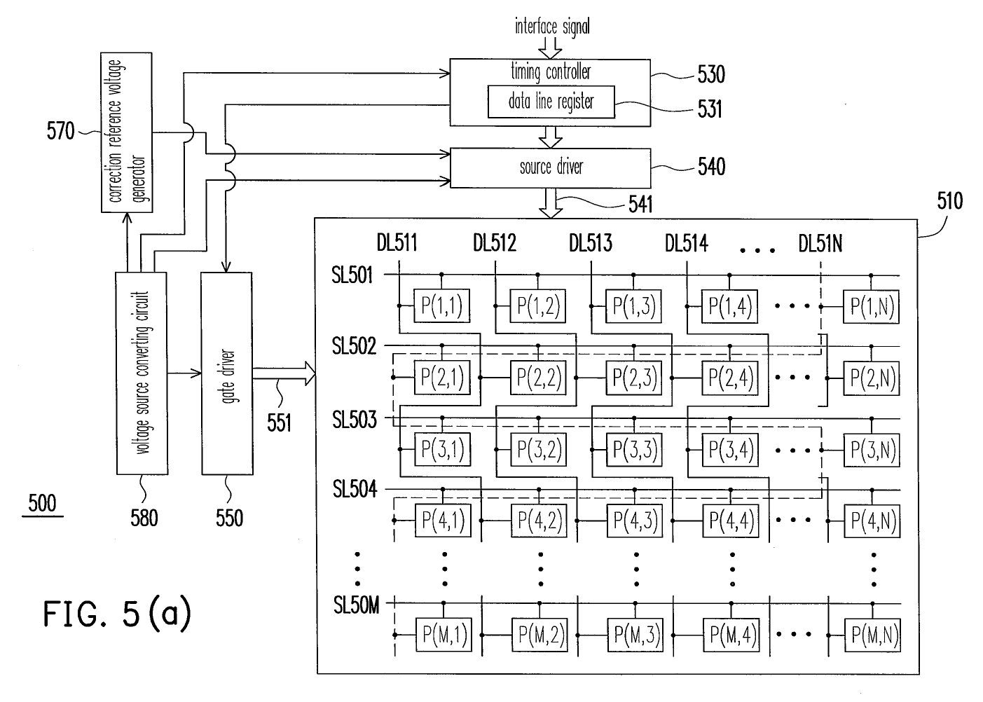

### DESCRIPTION OF EMBODIMENTS

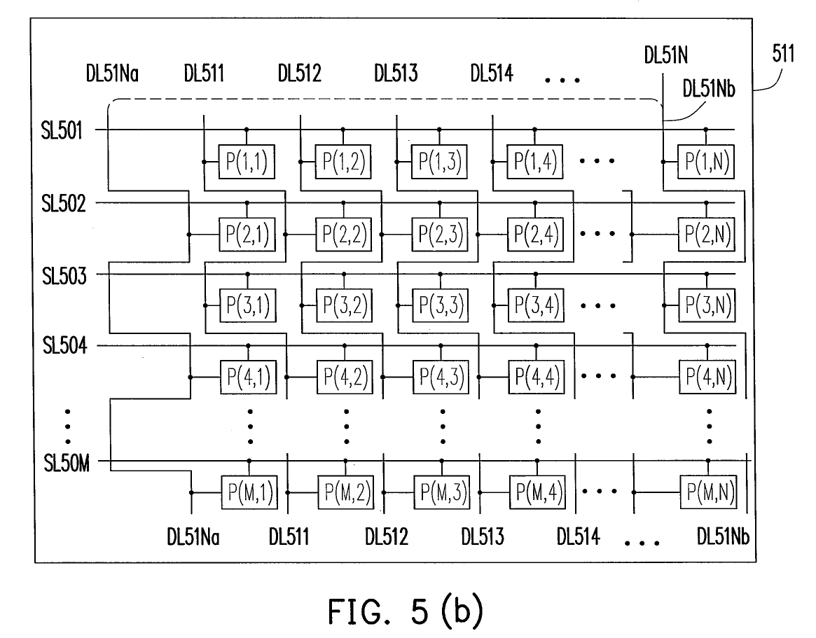

Referring to FIG. 5(a), it illustrates a plane display device according to one embodiment of the invention. A plane display device 500 includes a voltage source converting circuit 580, a Γ(gamma) correction reference voltage generator 570, a display panel 510, a timing controller 530, a source driver 540 and a gate driver 550. The voltage source converting circuit 580 provides electricity to the Γ correction reference voltage generator 570, the timing controller 530, the source driver 540 and the gate driver 550. The Γ correction reference voltage generator 570 provides a reference voltage to the source driver 540 for performing the Γ correction. The timing controller 530 is used for receiving interface signals and outputting data in sequence to the source driver 540. The timing controller 530 also controls the gate driver 550. In the present embodiment, the data line register 531 exists in the timing controller 530, but the invention is not limited to this example. The data line register 531 may also exist in the source driver 540, or the data line register 531 may be coupled between the timing controller 530 and the source driver 540. The source driver 540 is coupled to the timing controller 530 and transmits column signals 541 to the display panel 510 in coordination with timing. The column signals 541 include signals on the data lines DL511, DL512 . . . DL51N. The gate driver 550 is coupled to the timing controller 530 and transmits row signals 551 to the display panel 510 in coordination with timing.

The display panel 510 is coupled between the source driver 540 and the gate driver 550. The display panel 510 includes scan lines SL501, SL502 . . . SL50M; data lines DL511, DL512 . . . DL51N; and pixels P(1, 1), P(1, 2) . . . P(1, N), P(2, 1), P(2, 2) . . . P(2, N) . . . P(M, 1), P(M, 2) . . . P(M, N). Altogether, the display panel includes M rows of scan lines, N columns of data lines and M×N pixels are arranged as a matrix; M and N are positive integers. The column signals 551 include signals on the scan lines SL501, SL502 . . . SL50M. The display panel 510 drives the pixels on the display panel 510 according to the data signals received from the data lines DL511, DL512 . . . DL51N and the signals received from the scan lines SL501, SL502 . . . SL50M. The principles of the wiring route of the data lines are as follows. i, j, p and q are designated as integers, 1≦i≦M, 1≦j≦N, 1≦p<M and 1≦|q|<N. The pixel on the i^{th} row and in the j^{th} column is indicated as P(i,j). The j^{th} column data line is coupled to the pixel P(i,j) and extends from between the pixel P(i+p−1,j) and the pixel P(i+p,j) toward the direction between the pixel P(i+p−1,j+q) and the pixel P(i+p,j+q). The j^{th} column data line is also coupled to the pixel P(i+p,j+q) and extends between the pixel P(i+2p−1,j+q) and the pixel P(i+2p,j+q) toward the direction between the pixel P(i+2p−1,j) and the pixel P(i+2p,j). In addition, if q>0, the principles of the wiring route are as follows. The N^{th} column data line is coupled to the pixel P(i, N) and extends from between the pixel P(i+p−1, N) and the pixel P(i+p, N) toward the direction between the pixel P(i+p−1, q) and the pixel P(i+p,q). The N^{th} column data line is also coupled to the pixel P(i+p, q) and extends from between the pixel P(i+2p−1,q) and the pixel P(i+2p,q) toward the direction between the pixel P(i+2p−1, N) and the pixel P(i+2p, N). If q<0, the principles of the wiring route are as below. The first column data line is coupled to the pixel P(i, 1) and extends from between the pixel P(i+p−1, 1) and the pixel P(i+p, 1) toward the direction between the pixel P(i+p−1, N+q+1) and the pixel P(i+p, N+q+1). The first column data line is also coupled to the pixel P(i+p, N+q+1) and extends from between the pixel P(i+2p−1, N+q+1) and the pixel P(i+2p, N+q+1) toward the direction between the pixel P(i+2p−1, 1) and the pixel P(i+2p, 1).

Focusing on the embodiment of FIG. 5(a), if p=1 and q=1, the pixels P(1, 1)˜P(M, N) in the display panel 510 are arranged as a pixel matrix constituted by M×N pixels. The method of coupling the scan lines SL501˜SL50M is as follows. The scan line SL501 is horizontally coupled to the pixels P(1, 1), P(1, 2), P(1, 3) . . . P(1, N). The scan line SL502 is horizontally coupled to the pixels P(2, 1), P(2, 2), P(2, 3) . . . P(2, N). The scan line SL503 is horizontally coupled to the pixels P(3, 1), P(3, 2), P(3, 3) . . . P(3, N). Similarly, the scan line SL50M is horizontally coupled to the pixels P(M, 1), P(M, 2), P(M, 3) . . . P(M, N). Furthermore, the method of coupling the data lines DL51˜DN51N is as follows. The data line DL511 is coupled to the pixel P(1, 1) and extends from between the pixel P(1, 1) and the pixel P(2, 1) toward the direction between the pixel P(1, 2) and the pixel P(2, 2). The data line DL511 is also coupled to the pixel P(2, 2) and extends from between the pixel P(2, 2) and the pixel P(3, 2) toward the direction between the pixel P(2, 1) and the pixel P(3, 1). The data line DL511 is coupled to the pixel P(3, 1) and starts again from the pixel P(3, 1) to be further coupled to the pixel P(4, 2). . . . The data line DL512 is coupled to the pixel P(1, 2) and extends from between the pixel P(1, 2) and the pixel P(2, 2) toward the direction between the pixel P(1, 3) and the pixel P(2, 3). The data line DL512 is also coupled to the pixel P(2, 3) and extends from between the pixel P(2, 3) and the pixel P(3, 3) toward the direction between the pixel P(2, 2) and the pixel P(3, 2). The data line DL512 is coupled to the pixel P(3, 2) and starts again from the pixel P(3, 2) to be further coupled to the pixel P(4, 3). . . . The data line DL51N is coupled to the pixel P(1, N) and extends from between the pixel P(1, N) and the pixel P(2, N) toward the direction between the pixel P(1, 1) and the pixel P(2, 1). The data line DL51N is also coupled to the pixel P(2, 1) and extends from between the pixel P(2, 1) and the pixel P(3, 1) toward the direction between the pixel P(2, N) and the pixel P(3, N). The data line DL51N is coupled to the pixel P(3, N) and starts again from the pixel P(3, N) to be further coupled to the pixel P(4, 1). . . . It can be easily observed from FIG. 5(a) that the route of each of the data lines changes from one of the columns to another so as to connect with pixels in different columns.

FIG. 5(b) is a data line route structure diagram of a display panel according to another embodiment of the invention. Referring to FIG. 5(b), the only difference between the display panel 511 and the display panel 510 is that the data line DL51N includes data lines DL51Na and DL51Nb. The data line DL51Na is in charge of processing the pixels P(2, 1), P(4, 1) . . . P(M, 1). The furthest right data line DL51Nb is only in charge of processing the pixels P(1, N), P(3, N). . . . P(M−1, N).

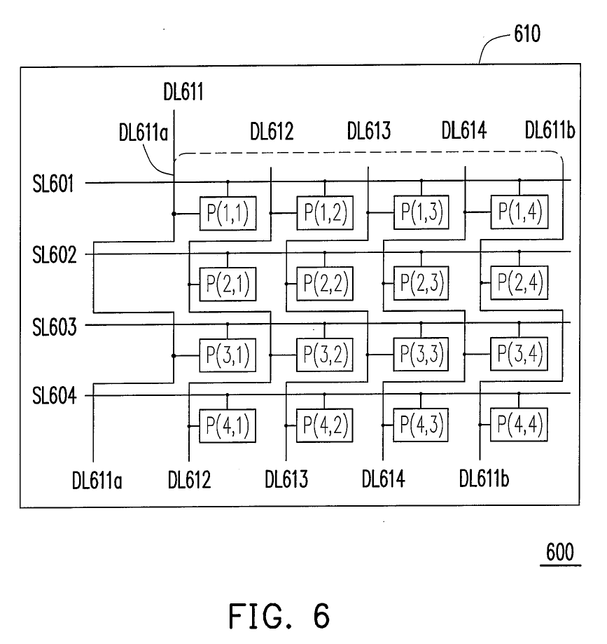

FIG. 6 is a data line route structure diagram of a display panel according to another embodiment of the invention. A plane display device 600 includes a display panel 610. The display panel 610 includes a 4×4 pixel matrix constituted by scan lines SL601˜SL604, data lines DL611˜DL614 and pixels P(1, 1)˜P(4, 4). The data line DL611 includes data lines DL611a and DL611b. In the present embodiment, M=4 and N=4. In the data line wiring route of the display panel 610, if p=1 and q=−1, the data line DL614 is coupled to the pixel P(1, 4) and extends from between the pixel P(1, 4) and the pixel P(2, 4) toward the direction between the pixel P(1, 3) and the pixel P(2, 3). The data line DL614 is also coupled to the pixel P(2, 3) and extends from between the pixel P(2, 3) and the pixel P(3, 3) toward the direction between the pixel P(2, 4) and the pixel P(3, 4). The data line DL614 is coupled to the pixel P(3, 4) and starts again from the pixel P(3, 4) to be further coupled to the pixel P(4, 3). The data line DL613 is coupled to the pixel P(1, 3) and extends from between the pixel P(1, 3) and the pixel P(2, 3) toward the direction between the pixel P(1, 2) and the pixel P(2, 2). The data line DL613 is also coupled to the pixel P(2, 2) and extends from between the pixel P(2, 2) and the pixel P(3, 2) toward the direction between the pixel P(2, 3) and the pixel P(3, 3). The data line DL613 is coupled to the pixel P(3, 3) and starts again from the pixel P(3, 3) to be further coupled to the pixel P(4, 2). The data line DL612 is coupled to the pixel P(1, 2) and extends from between the pixel P(1, 2) and the pixel P(2, 2) toward the direction between the pixel P(1, 1) and the pixel P(2, 1). The data line DL612 is also coupled to the pixel P(2, 1) and extends from between the pixel P(2, 1) and the pixel P(3, 1) toward the direction between the pixel P(2, 2) and the pixel P(3, 2). The data line DL612 is coupled to the pixel P(3, 2) and starts again from the pixel P(3, 2) to be further coupled to the pixel P(4, 1). The data line DL611 is coupled to pixels in the same way as the data lines DL612˜DL614 described above, but the coupling route is divided into two data lines DL611a and DL611b. The data line DL611a is coupled to the pixels P(1, 1) and P(3, 1) and the data line DL611b is coupled to the pixels P(2, 4) and P(4, 4).

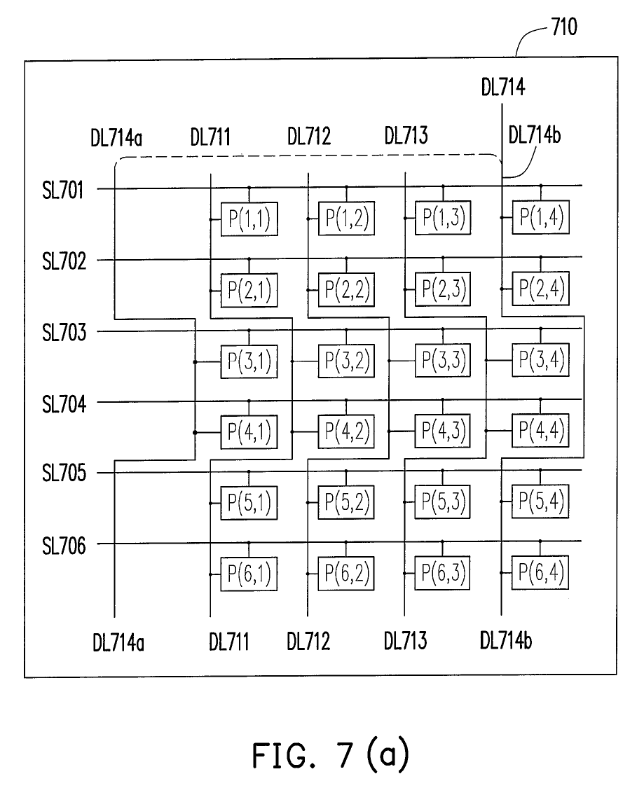

FIG. 7(a) is a data line route structure diagram of a display panel according to another embodiment of the invention. A plane display device 700 includes a display panel 710. The display panel 710 includes a 6×4 pixel matrix constituted by scan lines SL701˜SL706, data lines DL711˜DL714 and pixels P(1, 1)˜P(6, 4). The data line DL714 includes data lines DL714a and DL714b. In the present embodiment, M=6 and N=4. In the principles of the data line wiring route, if p=2 and q=1, the data line DL711 is coupled to the pixel P(1, 1) and the pixel P(2, 1) and extends from between the pixel P(2, 1) and the pixel P(3, 1) toward the direction between the pixel P(2, 2) and the pixel P(3, 2). The data line DL711 is also coupled to the pixels P(3, 2) and P(4, 2) and extends from between the pixel P(4, 2) and the pixel P(5, 2) toward the direction between the pixel P(4, 1) and the pixel P(5, 1). The data line DL711 is coupled to the pixels P(5, 1) and P(6, 1). The data line DL712 is coupled to the pixels P(1, 2) and P(2, 2) and extends from between the pixel P(2, 2) and the pixel P(3, 2) toward the direction between the pixel P(2, 3) and the pixel P(3, 3). The data line DL712 is also coupled to the pixels P(3, 3) and P(4, 3) and extends from between the pixel P(4, 3) and the pixel P(5, 3) toward the direction between the pixel P(4, 2) and the pixel P(5, 2). The data line DL712 is coupled to the pixels P(5, 2) and P(6, 2). The data line DL713 is coupled to the pixels P(1, 3) and P(2, 3) and extends from between the pixel P(2, 3) and the pixel P(3, 3) toward the direction between the pixel P(2, 4) and the pixel P(3, 4). The data line DL713 is also coupled to the pixels P(3, 4) and P(4, 4) and extends from between the pixel P(4, 4) and the pixel P(5, 4) toward the direction between the pixel P(4, 3) and the pixel P(5, 3). The data line DL713 is coupled to the pixels P(5, 3) and P(6, 3). The data line DL714 is coupled to pixels in the same way as the data lines DL711˜DL713 described above, but the coupling route is divided into two data lines DL714a and DL714b. The data line DL714b is coupled to the pixels P(1, 4), P(2, 4), P(5, 4) and P(6, 4), and the data line DL714a is coupled to the pixels P(3, 1) and P(4, 1).

Referring to FIG. 7(b), it illustrates a display panel 711 of another embodiment of the invention. The display panel 711 includes a 6×4 pixel matrix constituted by scan lines SL701˜SL706, data lines DL711˜DL714 and pixels P(1, 1)˜P(6, 4). The data line DL711 includes data lines DL711a and DL711b. In the present embodiment, M=6 and N=4. In the principles of the wiring route of the data lines, if p=2 and q=−1, the data line DL712 is coupled to the pixels P(1, 2) and P(2, 2) and extends from between the pixel P(2, 2) and the pixel P(3, 2) toward the direction between the pixel P(2, 1) and the pixel P(3, 1). The data line DL712 is also coupled to the pixels P(3, 1) and P(4, 1) and extends from between the pixel P(4, 1) and the pixel P(5, 1) toward the direction between the pixel P(4, 2) and the pixel P(5, 2). The data line DL712 is coupled to the pixels P(5, 2) and P(6, 2). The data line DL713 is coupled to the pixels P(1, 3) and P(2, 3) and extends from between the pixel P(2, 3) and the pixel P(3, 3) toward the direction between the pixel P(2, 2) and the pixel P(3, 2). The data line DL713 is also coupled to the pixels P(3, 2) and P(4, 2) and extends from between the pixel P(4, 2) and the pixel P(5, 2) toward the direction between the pixel P(4, 3) and the pixel P(5, 3). The data line DL713 is coupled to the pixels P(5, 3) and P(6, 3). The data line DL714 is coupled to the pixels P(1, 4) and P(2, 4) and extends from between the pixel P(2, 4) and the pixel P(3, 4) toward the direction between the pixel P(2, 3) and the pixel P(3, 3). The data line DL714 is also coupled to the pixels P(3, 3) and P(4, 3) and extends from between the pixel P(4, 3) and the pixel P(5, 3) toward the direction between the pixel P(4, 4) and the pixel P(5, 4). The data line DL714 is coupled to the pixels P(5, 4) and P(6, 4). The data line DL711 is coupled to pixels in the same way as the data lines DL712˜DL714 described above, but the coupling route is divided into two data lines DL711a and DL711b. The data line DL711a is coupled to the pixels P(1, 1), P(2, 1), P(5, 1) and P(6, 1). The data line DL711b is coupled to the pixels P(3, 4) and P(4, 4).

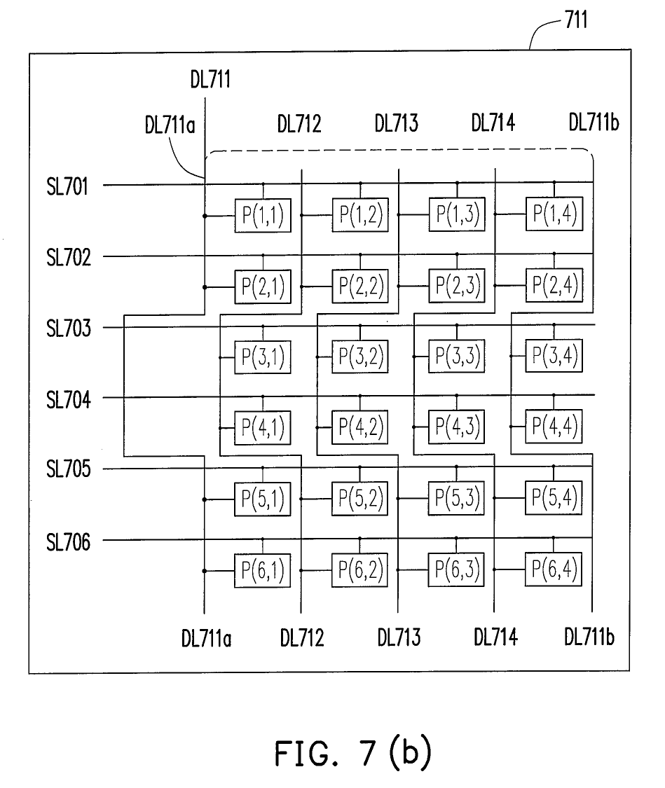

FIG. 8 is a data line route structure diagram of a display panel according to another embodiment of the invention. A plane display device 800 includes a display panel 810. The display panel 810 includes a 4×4 pixel matrix constituted by scan lines SL801˜SL804, data lines DL811˜DL814 and pixels P(1, 1)˜P(4, 4). The data line DL814 includes data lines DL814a and DL814b. In the present embodiment, M=4 and N=4. In the principle of the wiring route of the data lines, if p=1 and q=1, the data line DL811 is coupled to the pixel P(1, 1) and extends from between the pixel P(1, 1) and the pixel P(2, 1) toward the direction between the pixel P(1, 2) and the pixel P(2, 2). The data line DL811 is also coupled to the pixel P(2, 2) and extends from between the pixel P(2, 2) and the pixel P(3, 2) toward the direction between the pixel P(2, 1) and the pixel P(3, 1). The data line DL811 is coupled to the pixel P(3, 1) and starts again from the pixel P(3, 1) to be further coupled to the pixel P(4, 2). The data line DL812 is coupled to the pixel P(1, 2) and extends from between the pixel P(1, 2) and the pixel P(2, 2) toward the direction between the pixel P(1, 3) and the pixel P(2, 3). The data line DL812 is also coupled to the pixel P(2, 3) and extends from between the pixel P(2, 3) and the pixel P(3, 3) toward the direction between the pixel P(2, 2) and the pixel P(3, 2). The data line DL812 is coupled to the pixel P(3, 2) and starts again from the pixel P(3, 2) to be further coupled to the pixel P(4, 3). The data line DL813 is coupled to the pixel P(1, 3) and extends from between the pixel P(1, 3) and the pixel P(2, 3) toward the direction between the pixel P(1, 4) and the pixel P(2, 4). The data line DL813 is also coupled to the pixel P(2, 4) and extends from between the pixel P(2, 4) and the pixel P(3, 4) toward the direction between the pixel P(2, 3) and the pixel P(3, 3). The data line DL813 is coupled to the pixel P(3, 3) and starts again from the pixel P(3, 3) to be further coupled to the pixel P(4, 4). The data line DL814 is coupled to pixels in the same way as the data lines DL811˜DL813 described above, but the coupling route is divided into two data lines DL814a and DL814b. The data line DL814b is coupled to the pixels P(1, 4) and P(3, 4) and the data line DL814a is coupled to the pixels P(2, 1), P(3, 1) and P(4, 1).

According to FIGS. 5(a), 5(b), 6, 7(a), 7(b) and 8, the display panels 510, 511, 610, 710, 711 and 810 are merely examples of the present invention. The invention does not limit the numbers of data lines and scan lines of a display panel. Neither does the invention limit the number of pixels contained in each scan line row. The general principle is if there are M×N pixels, each scan line row includes M pixels, and the route of each of the data lines changes from one of the columns to another so as to connect with pixels in different columns.

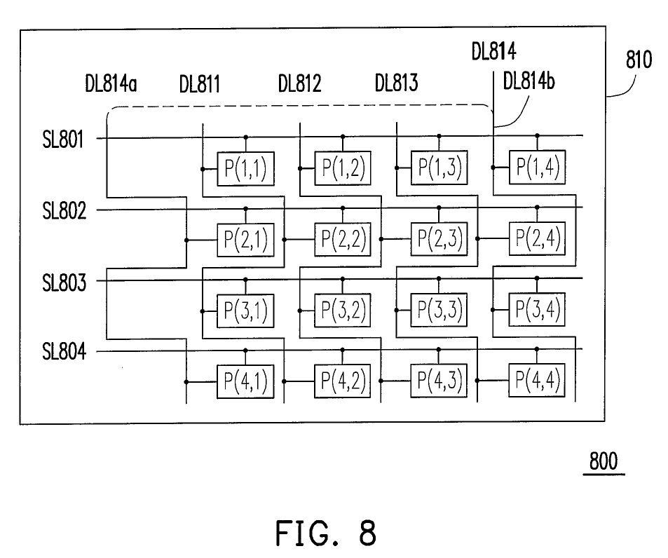

Referring to FIGS. 9 and 8, FIG. 9 illustrates the internal data route of a data line register 903 and the data line register 903 is used in the display device 800 of FIG. 8. Frame data 901 to be transmitted before the sequencing process undergo a data exchange inside the data line register 903 and become frame data 902 to be transmitted after the sequencing process. The frame data 902 to be transmitted after the sequencing process are sent to the display panel 810 through the source driver (not shown). As a result, the display panel 810 displays the frame data in coordination with the operations of scan lines SL801˜SL804. Taking the data line DL811 as shown in FIG. 9 as an example, data A are sent to the pixel P(1, 1) when the scan line SL801 operates; data B are sent to the pixel P(2, 2) when the scan line SL802 operates; the data A are sent to the pixel P(3, 1) when the scan line SL803 operates and the data B are sent to the pixel P(4, 2) when the scan line SL804 operates. Taking data lines DL814a and DL814b as examples, when the scan line SL801 operates, the data line DL814b sends data D to the pixel P(1, 4); when the scan line SL802 operates, the data line DL814a sends data A to the pixel P(2, 1); when the scan line SL803 operates, the data line DL814b sends data D to the pixel P(3, 4); when the scan line SL804 operates, the data line DL814a sends data A to the pixel P(4, 1). Additionally, the transmitted data of the data lines DL812˜DL813 are shown as FIG. 9 and hence are not to be reiterated herein.

As to the data exchange inside the data line register 903, people who are ordinarily skilled in the related art of the invention should know that in order to implement the data exchange inside the data line register 903, the route changes from one of the columns to another in coordination with the data lines of the display panel 810 so as to connect with pixels of different columns so that the data line register 903 controls the internal data routes to accurately transmit the positions of pixels accordingly.

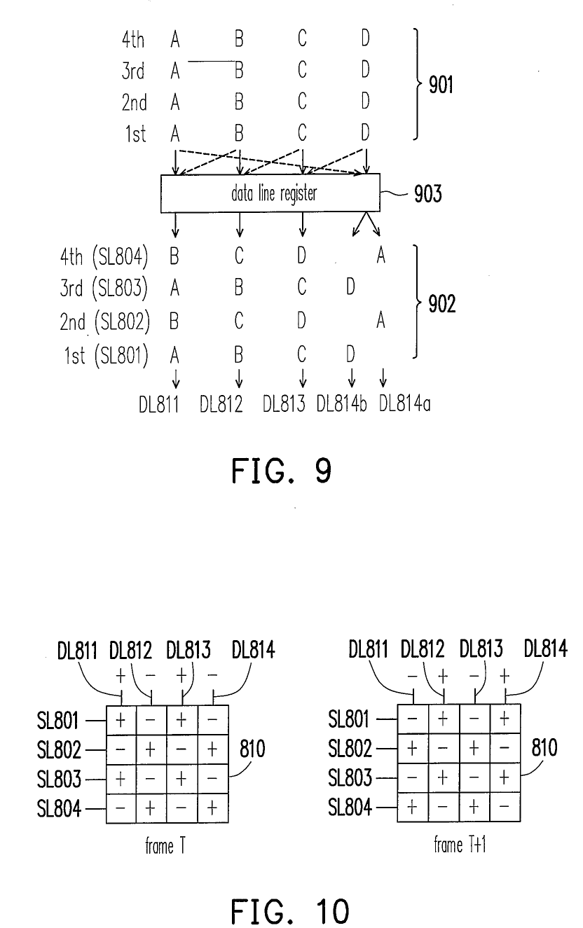

FIG. 10 is a schematic diagram of the driving method of the embodiment in FIG. 8. The driving polarities of the data lines DL811˜DL814 are indicated with + and −. + represents a positive polarity driven mode and − represents a negative polarity driven mode. A positive polarity driven mode means a data-transmitting voltage is higher than a common voltage (not shown), and a negative polarity driven mode means a data-transmitting voltage is lower than a common voltage. In the frame T, the data lines DL811 and DL813 are positive polarity driven and the data lines DL812 and DL814 are negative polarity driven. When different scan line rows are operating, the voltage polarities of the data lines DL811˜DL814 do not need to invert. Only when entering the next frame, do the voltage polarities of the data lines DL811˜DL814 need to be inverted. That is, the data lines DL811 and DL813 are negative polarity driven and the data lines DL812 and DL814 are positive polarity driven. It can be seen that in the same frame, adjacent pixels, either in the horizontal or the vertical direction, have opposite driving polarities. The driving polarity of one pixel is inverted when entering the next frame. The route of each of the data lines in the display panel 810 changes from one of the columns to another and connects with pixel structures and driving methods of different columns so that the best display quality and effect of the dot inversion method is achieved. Moreover, since it is unnecessary to perform the data line voltage polarity inversion when entering the next scan line row, the number of times of applying a cross voltage is reduced and the power consumption is thus lowered.

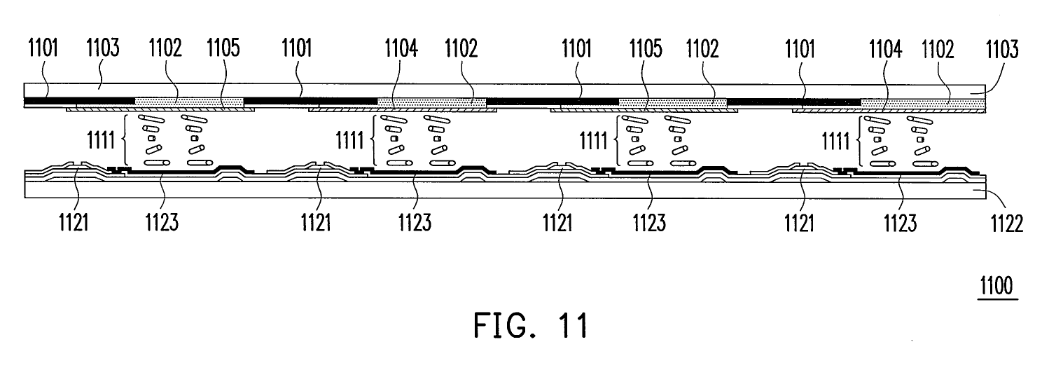

Referring to FIG. 11, it is a structure diagram of a display panel according to another embodiment of the invention. A display panel 1100 includes a thin film transistor array substrate 1122, a color filter substrate 1103 and a liquid crystal layer 1111. The liquid crystal layer 1111 is disposed between the thin film transistor array substrate 1122 and the color filter substrate 1103. The color filter substrate 1103 includes a common electrode layer 1104 and a common electrode layer 1105. The thin film transistor array substrate 1122 includes a thin film transistor 1121 and a pixel electrode 1123. In one embodiment of the invention, the color filter substrate 1103 may further include a color filter layer 1102. The color filter layer 1102 is used for displaying colors in coordination with pixels. Furthermore, the color filter layer 1102 further includes a black opaque layer 1101. The black opaque layer 1101 is used for shielding interferences of color mixing and light leakage among different pixels so as to increase the contrast and render the quality of pixels more stable and clear.

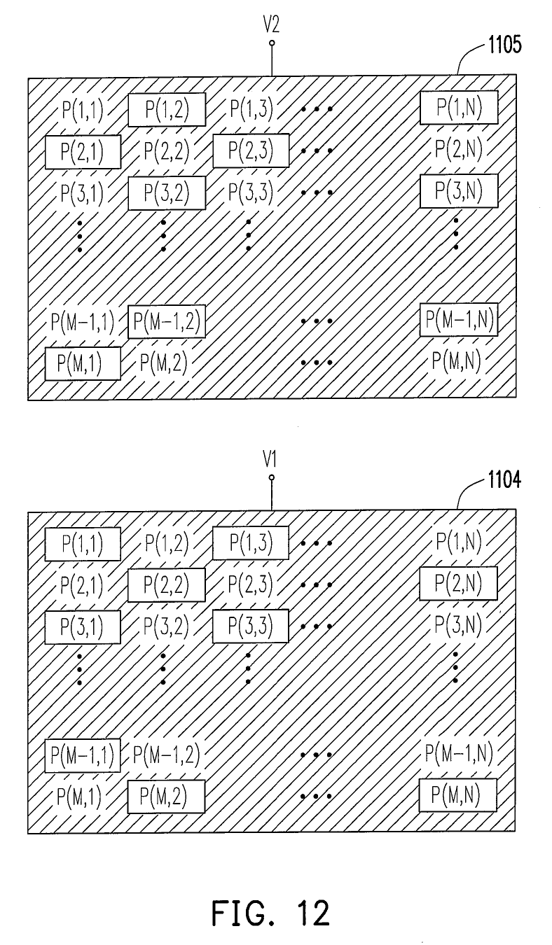

FIG. 12 is a top view of the display panel of FIG. 11. The thin film transistor array substrate on the display panel 1100 includes M×N pixels arranged as a matrix. M and N are positive integers. A voltage V1 is applied to the common electrode layer 1104 of the color filter substrate, and a voltage V2 is applied to the common electrode layer 1105. The principle of arranging common electrode layers to correspond to pixel electrodes are as follows. i, j, p and q are designated as integers, and 1≦i≦M, 1≦j≦N, 1≦p<M and 1≦q<N. The pixel on the i^{th} row and in the j^{th} column is indicated as P(i,j). The pixel electrodes of the pixels P(i,j) and P(i+p, j+q) are arranged as perpendicular to the common electrode layer 1105. The pixel electrode of the pixel P(i+p,j) is arranged as perpendicular to the common electrode layer 1104. The embodiment of FIG. 12 illustrates an example when p=1 and q=1.

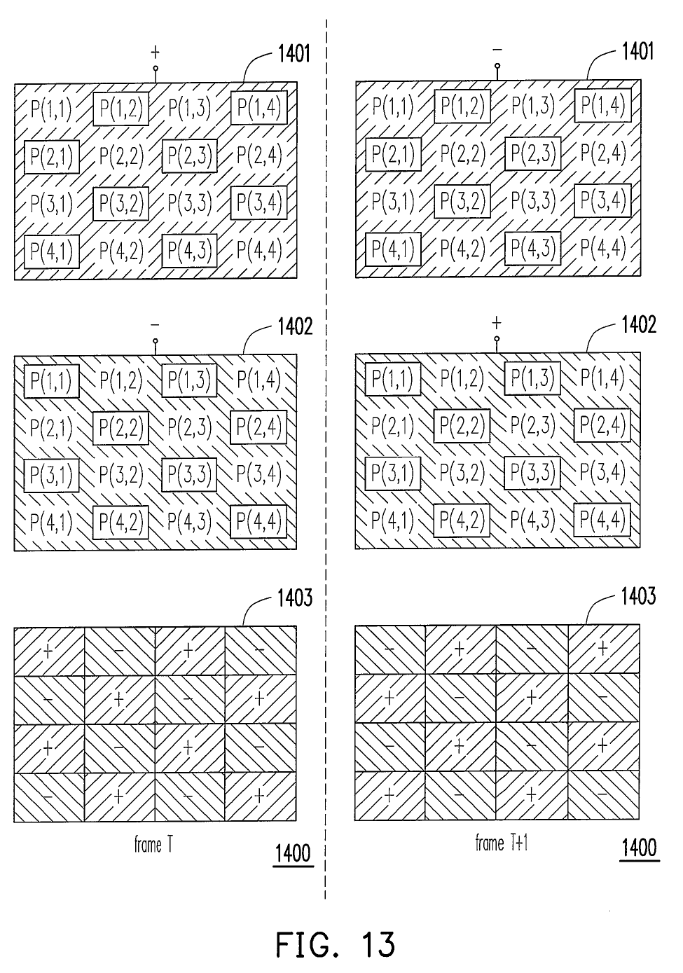

It should be understood that the invention is not limited to the above embodiment. FIG. 13 illustrates a top view of a display panel and a schematic diagram of a driving method according to another embodiment of the invention. A display panel 1400 of FIG. 13 has the same structure as the display panel 1100 of FIG. 11. The only difference between the two display panels is that the thin film transistor array substrate of FIG. 13 is a pixel matrix 1403 constituted by 4×4 pixels and a color filter substrate including a common electrode layer 1402 and a common electrode layer 1401. Each of the pixels has an independent pixel electrode (not shown). The pixel electrodes are arranged into a two-dimensional array. The pixel electrode of each of the pixels and its perpendicularly corresponding common electrode layer are arranged in a special sequence. i and j are designated as integers, and p=1, q=1, 1≦i≦4 and 1≦j≦4. The pixel on the i^{th} row and in the j^{th} column is indicated as P(i,j). The pixel electrodes of the pixels P(i,j) and P(i+p, j+q) are arranged as perpendicular to the common electrode layer 1401. The pixel electrode of the pixel P(i+p,j) and the common electrode layer 1402 are arranged as perpendicular to each other. Taking the embodiment of FIG. 13 as an example, the pixel electrodes of the pixels P(1, 1), P(1, 3), P(2, 2), P(2, 4), P(3, 1), P(3, 3), P(4, 2), and P(4, 4) are arranged as perpendicular to the common electrode layer 1401. The positions in the common electrode layer 1401 perpendicularly arranged to correspond to the pixel electrodes of the pixels P(1, 2), P(1, 4), P(2, 1), P(2, 3), P(3, 2), P(3, 4), P(4, 1) and P(4, 3) are all empty. Furthermore, the pixel electrodes of the pixels P(1, 2), P(1, 4), P(2, 1), P(2, 3), P(3, 2), P(3, 4), P(4, 1) and P(4, 3) are arranged as perpendicular to the common electrode layer 1402. The positions in the common electrode layer 1402 perpendicularly arranged to correspond to the pixel electrodes of the pixels P(1, 1), P(1, 3), P(2, 2), P(2, 4), P(3, 1), P(3, 3), P(4, 2) and P(4, 4) are all empty.

Still referring to FIG. 13, the common electrode layer 1402, the common electrode layer 1401 and the voltage differences among the pixel electrodes of all the pixels are formed as in the positive polarity driven mode or in the negative polarity driven mode. The positive polarity driven mode and negative polarity driven mode are respectively indicated with + and −. In the frame T, a voltage is applied to the common electrode layer 1401 to generate a positive polarity driving voltage and a voltage is applied to the common electrode layer 1402 to generate a negative polarity driving voltage. As a result, adjacent pixels in a pixel matrix 1403 in the same frame, either in the horizontal or the vertical direction, have opposite driving polarities. In the frame T+1, the voltages applied by the common electrode layer 1401 and the common electrode layer 1402 are exchanged. In other words, a negative polarity driving voltage is applied to the common electrode layer 1401 and a positive polarity driving voltage is applied to the common electrode layer 1402. The driving polarities of both common electrode layers are also inverted in the pixel matrix 1403. In one embodiment of the invention, since the display panel 1400 has a structure wherein pixels at different positions are perpendicularly arranged to correspond to different common electrode layers and the driving methods of applying voltages are controlled, the best display quality and effect of the dot inversion are achieved. Additionally, in the same frame, either in the horizontal or the vertical direction, the voltage polarity of each data line column or each scan line row does not have to invert. As a result, the number of times of applying a cross voltage is significantly reduced and hence the power consumption is lowered.

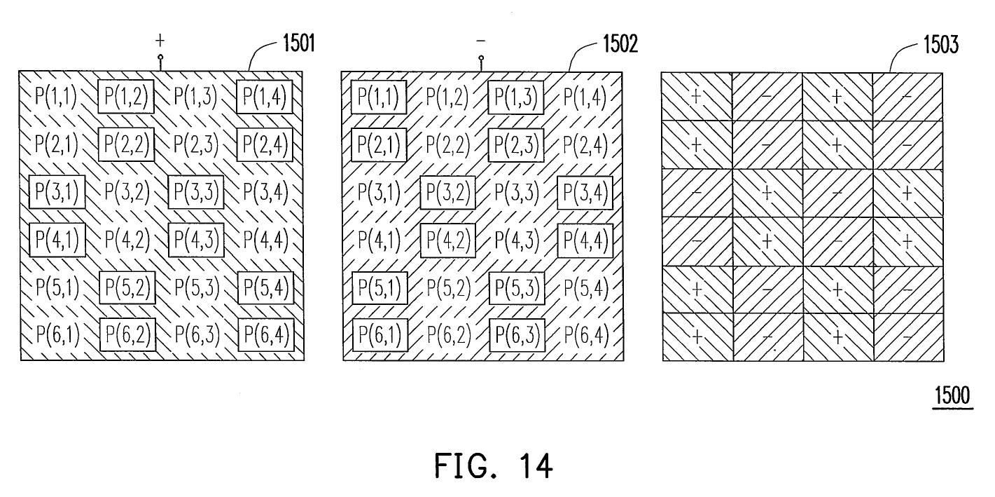

FIG. 14 illustrates a schematic diagram of a top view of a display panel according to another embodiment of the invention. A display panel 1500 of FIG. 14 has the same structure as the display panel 1100 of FIG. 11. The only difference between both display panels is that the thin film transistor array substrate of FIG. 14 is a pixel matrix 1503 constituted by 6×4 pixels and a color filter substrate including a common electrode layer 1502 and a common electrode layer 1501. Each of the pixels has an independent pixel electrode (not shown). The pixel electrodes are arranged into a two-dimensional array. The pixel electrode of each of the pixels and its perpendicularly corresponding common electrode layer are arranged in a specific sequence. i and j are designated as integers, and p=2, q=1, 1≦i≦6 and 1≦j≦4. The pixel on the i^{th} row and in the j^{th} column is indicated as P(i,j). The pixel electrodes of the pixels P(i,j) and P(i+p,j+q) are arranged as perpendicular to the common electrode layer 1501. The pixel electrode of the pixel P(i+p,j) and the common electrode layer 1502 are arranged as perpendicular to each other. Taking the embodiment of FIG. 14 as an example, the pixel electrodes of the pixels P(1, 1), P(1, 3), P(2, 1), P(2, 3), P(3, 2), P(3, 4), P(4, 2), P(4, 4), P(5, 1), P(5, 3), P(6, 1) and P(6, 3) are arranged as perpendicular to the common electrode layer 1501. The pixel electrodes of the pixels P(1, 2), P(1, 4), P(2, 2), P(2, 4), P(3, 1), P(3, 3), P(4, 1), P(4, 3), P(5, 2), P(5, 4), P(6, 2) and P(6, 4) are arranged as perpendicular to the common electrode layer 1502.

Still referring to FIG. 14, the common electrode layer 1501, the common electrode layer 1502 and the voltage differences among the pixel electrodes of all the pixels are formed as positive polarity driven and negative polarity driven. A positive polarity driven mode and a negative polarity driven mode are respectively indicated with + and −. A positive polarity driving voltage is applied to the common electrode layer 1501 and a negative polarity driving voltage is applied to the common electrode layer 1502. As a result, the driving polarity of the pixel matrix 1503 has a certain special effect. When frames are changing, if a negative polarity driving voltage is applied to the common electrode layer 1501 and a positive polarity driving voltage is applied to the common electrode layer 1502, the driving polarities of both electrode layers are also inverted in the pixel matrix 1503.

It is known from the descriptions of the embodiments of FIGS. 13 and 14 that in the same frame, either in the horizontal or the vertical direction, the voltage polarity of each data line column and the voltage polarity of each scan line row do not have to invert. Since the display panel has a structure wherein pixels at different positions are perpendicularly arranged to correspond to different common electrode layers and the driving methods of applying voltages are controlled, the best display quality and effect of the dot inversion are achieved. Therefore, the invention improves the frame quality and significantly reduces the number of times of applying a cross voltage such that the power consumption is lowered.

Although the present invention has been disclosed above by the embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A display panel, suitable for use in a plane display device, the display panel comprising:
M rows of scan lines, wherein M is a positive integer;
N columns of data lines, wherein N is a positive integer; and
M×N pixels, arranged as a matrix, the pixel on the i^{th} row and in the j^{th} column being indicated as P(i,j), wherein i and j are integers, 1≦i≦M and 1≦j≦N, the j^{th} column data line coupled to the pixel P(i,j), the j^{th} column data line extending between the pixel P(i+p−1,j) and the pixel (i+p,j) toward the direction between the pixel P(i+p−1, j+q) and the pixel P(i+p,j+q), the j^{th} column data line also coupled to the pixel P(i+p, j+q) and extending between the pixel P(i+2p−1,j+q) and the pixel P(i+2p,j+q) toward the direction between the pixel P(i+2p−1,j) and the pixel P(i+2p,j), wherein p and q are integers, 1≦p<M and 1≦|q|<N.

2. The display panel of claim 1, wherein when q>0, the N^{th} column data line is coupled to the pixel P(i, N) and extends from between the pixel P(i+p−1, N) and the pixel P(i+p, N) toward the direction between the pixel P(i+p−1, q) and the pixel P(i+p, q), the N^{th} column data line also coupled to the pixel P(i+p, q) and extending from between the pixel P(i+2p−1, q) and the pixel P(i+2p, q) toward the direction between the pixel P(i+2p−1, N) and the pixel P(i+2p, N).

3. The display panel of claim 1, wherein when q<0, the first column data line is coupled to the pixel P(i, 1) and extends from between the pixel P(i+p−1, 1) and the pixel P(i+p, 1) toward the direction between the pixel P(i+p−1, N+q+1) and the pixel P(i+p, N+q+1), the first column data line also coupled to the pixel P(i+p, N+q+1) and extending from between the pixel P(i+2p−1, N+q+1) and the pixel P(i+2p, N+q+1) toward the direction between the pixel P(i+2p−1, 1) and the pixel P(i+2p, 1).

4. A panel display device, comprising:
a timing controller, used for outputting data in the order of timing;
a source driver, coupled to the timing controller;
a gate driver, coupled to the timing controller; and
a display panel, coupled between the source driver and the gate driver, the display panel comprising:
M rows of scan lines, driven by the gate driver, wherein M is a positive integer;
N columns of data lines, driven by the source driver, wherein N is a positive integer;
M×N pixels, arranged as a matrix, the pixel on the i^{th} row and in the j^{th} column being indicated as P(i,j), wherein i and j are integers, 1≦i≦M and 1≦j≦N,
wherein the j^{th} column data line is coupled to the pixel P(i, j) and extends from between the pixel P(i+p−1, j) and the pixel P(i+p, j) toward the direction between the pixel P(i+p−1, j+q) and the pixel P(i+p, j+q), the j^{th} column data line also coupled to the pixel P(i+p, j+q) and extending from between the pixel P(i+2p−1, j+q) and the pixel P(i+2p, j+q) toward the direction between the pixel P(i+2p−1, j) and the pixel P(i+2p,j), wherein p and q are integers, 1≦p<M and 1≦|q|<N.

5. The plane display device of claim 4, wherein when q>0, the N^{th} column data line is coupled to the pixel P(i, N) and extends from between the pixel P(i+p−1, N) and the pixel P(i+p, N) toward the direction between the pixel P(i+p−1, q) and the pixel P(i+p, q), the N^{th} column data line also coupled to the pixel P(i+p, q) and extending from between the pixel P(i+2p−1, q) and the pixel P(i+2p, q) toward the direction between the pixel P(i+2p−1, N) and the pixel P(i+2p, N).

6. The plane display device of claim 4, wherein when q<0, the first column data line is coupled to the pixel P(i, 1) and extends from between the pixel P(i+p−1, 1) and the pixel P(i+p, 1) toward the direction between the pixel P(i+p−1, N+q+1) and the pixel P(i+p, N+q+1), the first column data line also coupled to the pixel P(i+p, N+q+1) and extending from between the pixel P(i+2p−1, N+q+1) and the pixel P(i+2p, N+q+1) toward the direction between the pixel P(i+2p−1, 1) and the pixel P(i+2p, 1).

7. The plane display device of claim 4, wherein the plane display device further comprises a data line register, data sent to the data line register through the timing controller, data being sorted and rearranged by the data line register, when the i^{th} row scan line being enabled, the j^{th} column data line transmitting the data of the pixel P(i, j); when the (i+p)^{th} row scan line being enabled, the j^{th} column data line transmitting the data of the pixel P(i+p, j+q); when the (i+2p)^{th} row scan line being enabled, the j^{th} column data line transmitting the data of the pixel P(i+2p,j).

8. The plane display device of claim 7, wherein after the data being sorted and rearranged by the data line register, the j^{th} column data line transmits in order the data of the pixels P(i, j), P(i+1, j) . . . P(i+p−1, j), P(i+p, j+q), P(i+p+1, j+q) . . . P(i+2p−1, j+q) and P(i+2p, j).

9. The data line register of the plane display device of claim 7, wherein when q>0, after the data transmitted by the N^{th} column data line being sorted and rearranged by the data line register, the N^{th} column data line transmits in order the data of the pixels P(i, N), P(i+1, N) . . . P(i+p−1, N), P(i+p, q), P(i+p+1, q) . . . P(i+2p−1, q) and P(i+2p, N).

10. The data line register of the plane display device of claim 7, wherein when q<0, after the data transmitted by the first column data line being sorted and rearranged by the data line register, the first column data line transmits in order the data of the pixels P(i, 1), P(i+1, 1) . . . P(i+p−1, 1), P(i+p, N+q+1), P(i+p+1, N+q+1) . . . P(i+2p−1, N+q+1) and P(i+2p, 1).

11. A display panel, suitable for use in a plane display device, the display panel comprising:
a thin film transistor array substrate, comprising M×N pixels, arranged as a matrix, the pixel on the i^{th} row and in the j^{th} column being indicated as P(i,j), wherein M, N, i and j are positive integers, 1≦i≦M and 1≦j≦N;
a color filter substrate, comprising:
a first common electrode layer, applying a first voltage; and
a second common electrode layer, applying a second voltage; and
a liquid crystal layer, disposed between the thin film transistor array substrate and the color filter substrate;
wherein the pixel electrodes of the pixels P(i,j) and P(i+p, j+q) are arranged as perpendicular to the first common electrode layer and the pixel electrode of the pixel P(i+p,j) is arranged as perpendicular to the second common electrode layer, p and q being integers, 1≦p<M and 1≦q<N.

12. The display panel of claim 11, the first voltage and the second voltage applied respectively by the first common electrode layer and the second electrode layer are exchanged during frame changes.

13. The display panel of claim 11, wherein the color filter substrate further comprises a color filter layer and the color filter layer is used for displaying colors in coordination with pixels.

14. The display panel of claim 13, wherein the color filter layer further comprises a black opaque layer and the black opaque layer is used for shielding the interference of light leakage among different pixels.
